(19) United States
(12) Patent Application Publication
(10) Pub. No.: US 2011/0233174 A1
(43) Pub. Date: Sep. 29, 2011

(54) SPOT WELDING METHOD

(75) Inventors: Kaoru Shibata, Utsunomiya-shi (JP); Mitsutaka Igaue, Utsunomiya-shi (JP); Yushi Aoki, Utsunomiya-shi (JP)

(73) Assignee: HONDA MOTOR CO., LTD., Tokyo (JP)

(21) Appl. No.: 13/052,378

(22) Filed: Mar. 21, 2011

(30) Foreign Application Priority Data
Mar. 24, 2010 (JP) 2010-067664

(51) Int. Cl. B23K 11/11

(52) U.S. Cl. 219/91.2

(57) ABSTRACT

For spot-welding a plurality of metal workpieces, the metal workpieces are gripped and pressed under a pressing force by a pair of electrode tips, thereby forming a contact interface between the metal workpieces. Then, an electric current is passed between the electrode tips, and it is determined whether the contact interface is melted or not. Simultaneously when it is judged that the contact interface is melted, the pressing force applied from the electrode tips to the metal workpieces is reduced to such a level that the electrode tips and the metal workpieces are kept in contact with each other, the metal workpieces are kept in contact with each other, and the electric current keeps flowing between the electrode tips.

### CROSS-REFERENCE TO RELATED APPLICATION

This application is based upon and claims the benefit of priority from Japanese Patent Application No. 2010-067664 filed on Mar. 24, 2010, of which the contents are incorporated herein by reference.

### BACKGROUND OF THE INVENTION

1. Field of the Invention

The present invention relates to a spot welding method for passing an electric current between a pair of electrode tips which are gripping therebetween superposed regions of a plurality of metal workpieces for thereby joining the superposed regions.

2. Description of the Related Art

According to a spot welding process as one welding technique, as well known in the art, superposed regions of a plurality of metal workpieces are gripped by a pair of electrode tips, and an electric current is passed between the electrode tips to spot-weld the superposed regions. The superposed regions may be local regions of the metal workpieces or may be the metal workpieces in their entirety.

The spot welding process is performed by a welding gun mounted on the distal end of an arm of a robot that can be taught for welding operation. Specifically, the robot that has been trained operates to insert the superposed regions between the electrode tips that are mounted respectively on openable and closable clamps of the welding gun, and then to close the clamps to grip and press the superposed regions with the electrode tips.

With the clamps closed, when an electric current is then passed between the electrode tips, the contact interface formed between the superposed regions is heated and melted by way of resistance heating, developing a melted region. The melted region is then solidified into a spot-like nugget in the contact interface.

According to Japanese Laid-Open Patent Publication No. 2009-241112, three metal sheets that are superposed with the thinnest metal sheet being positioned as an outermost metal sheet. When the metal sheets are spot-welded, a pair of electrode tips grip the superposed regions of the metal sheets, and the pressing force applied from the electrode tips to the superposed regions is increased in a late stage of the spot welding process. Japanese Laid-Open Patent Publication No. 2009-241112 discloses that although it is not easy with the ordinary spot-welding process to grow a nugget between the outermost metal sheet, i.e., the thinnest metal sheet, and a metal sheet immediately beneath the outermost metal sheet, a nugget of sufficient size can be grown when the pressing force is changed as described above.

For joining two superposed metal sheets, there has also been proposed in the art a spot welding process which changes the pressing force applied to superposed regions while the welding is in progress. Specifically, according to Japanese Patent Publication No. 01-030593, the electric resistance between a pair of electrode tips is measured, and the measured electric resistance is compared with a preset value at each given time. When the difference between the measured electric resistance and the preset value exceeds a predetermined quantity, the pressing force is changed.

The pressing force is controlled such that the measured electric resistance approaches the preset value. Specifically, if the measured electric resistance exceeds the preset value, then the pressing force is increased to reduce the electric resistance between the electrode tips. If the measured electric resistance is lower than the preset value, then the pressing force is reduced to increase the electric resistance between the electrode tips.

When the pressing force is increased in the later stage of the spot welding process as disclosed in Japanese Laid-Open Patent Publication No. 2009-241112, the melted region which has not fully been solidified is pressed. Therefore, external forces applied to the melted region increase, resulting in a greater tendency for the melted metal to scatter out of the superposed regions, i.e., a greater tendency to cause sputtering.

Even when the pressing force is reduced in the later stage of the spot welding process as disclosed in Japanese Patent Publication No. 01-030593, the melted region and hence the nugget cannot be grown to a sufficient size.

As described above, the spot welding processes according to the related art are problematic in that it is not easy to grow a nugget of large size while preventing sputtering from taking place.

### SUMMARY OF THE INVENTION

It is an object of the present invention to provide a spot welding method which is capable of preventing sputtering and sparks (explosive fire) from taking place.

Another object of the present invention is to provide a spot welding method which is capable of growing a nugget to a large size.

According to the present invention, there is provided a spot welding method comprising the steps of:

pressing a plurality of metal workpieces under a pressing force with a pair of electrode tips gripping superposed regions of the metal workpieces, thereby bringing the metal workpieces into contact with each other to form a contact interface therebetween;

passing an electric current between the pair of electrode tips;

detecting whether the contact interface is melted or not; and

simultaneously when it is detected that the contact interface is melted, reducing the pressing force applied from the pair of electrode tips to the metal workpieces to such a level that the electrode tips and the metal workpieces are kept in contact with each other, the metal workpieces are kept in contact with each other, and the electric current keeps flowing between the electrode tips. The term “simultaneously” referred to above is used to cover an inevitable time lag after the formation of the melted region is detected until the pressing force is actually reduced.

At the same time that the melted region is detected as being formed, the pressing force applied to superposed regions of the metal workpieces is reduced to reduce the area of contact in the contact interface between the superposed regions and to increase the contact resistance of the contact interface. Therefore, the melted region and hence a nugget to be developed therefrom are grown to a large size.

At this time, because the pressing force is reduced, excessively large forces are prevented from being applied to the melted region, which is thus prevented from being crushed. Accordingly, sputtering is prevented from taking place while the spot-welding process is in progress.

If the pressing force is excessively reduced, the contact resistance is excessively increased, resulting in a tendency to cause sparks. To avoid such sparks, after the pressing force is reduced, it should preferably be set to such a level that an area of contact for preventing sparks from being produced is maintained in the contact interface between the superposed regions. Therefore, sparks are reliably prevented from being produced.

The pressing force for preventing sputtering and sparks from taking place may be determined in advance by spot-welding a test piece having substantially the same electric resistance as the superposed regions.

It may be judged that the contact interface is melted, i.e., the melted region is formed, when the value of an electric resistance between the electrode tips is changed, e.g., a rate of change in the value of the electric resistance is reduced.

Specifically, until the melted region is formed, the value of the electric resistance between the electrode tips sharply increases. When the melted region is formed, the value of the electric resistance between the electrode tips increases at a reduced rate, i.e., the value of the electric resistance between the electrode tips changes at a reduced rate. Therefore, it can be judged that the melted region is formed by detecting when the rate at which the value of the electric resistance between the electrode tips increases, i.e., the rate of change in the value of the electric resistance between the electrode tips, is reduced.

Alternatively, it may be judged that the melted region is formed when a velocity or a rate of change in a velocity of an ultrasonic wave emitted toward the contact interface is changed.

The velocity of the ultrasonic wave is reduced as the temperature of the superpose regions rises. When the high-temperature melted region is formed, the velocity of the ultrasonic wave (transmitted wave) which passes through the superposed regions is simultaneously reduced. Therefore, it can be judged that the melted region is formed by detecting when the velocity of the transmitted wave is changed.

The rate at which the temperature of the superposed regions increases is large until the melted region is formed. However, the rate at which the temperature of the superposed regions increases is reduced when the melted region is formed. When the rate at which the temperature of the superposed regions increases is reduced, the rate of change in the velocity of the transmitted wave is also reduced. Consequently, it can be judged that the melted region is formed by detecting when the rate of change in the velocity of the transmitted wave is reduced.

A longitudinal wave contained in the ultrasonic wave is capable of passing through both a solid phase and a liquid phase, whereas a transverse wave contained in the ultrasonic wave is incapable of passing through a liquid phase. Therefore, when the melted region is formed, the transverse wave contained in the ultrasonic wave is reflected by an interface of the melted region as a reflected wave. Stated otherwise, a reflected wave is not generated until the melted region is formed.

Therefore, a reflected wave may be confirmed as returning from the contact interface. It can thus be judged that the contact interface is melted, i.e., the melted region is formed, by confirming a reflected wave returning from the contact interface.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is an enlarged fragmentary front view, partly in block form, of a spot welding apparatus which carries out a spot welding method according to an embodiment of the present invention;

FIG. 2 is an enlarged fragmentary front view showing the manner in which an electric current starts being passed between a first electrode tip and a second electrode tip of the spot welding apparatus;

FIG. 3 is an enlarged fragmentary front view showing the manner in which a melted region is formed between a first metal sheet and a second metal sheet as superposed regions;

FIG. 4 is a graph showing how the electric resistance value from the first electrode tip to the second electrode tip changes with time from the time when the electric current starts being passed between the first electrode tip and the second electrode tip to the time when the electric current ends being passed between the first electrode tip and the second electrode tip, when sputtering takes place, when sparks take place, and when both sputtering and sparks do not take place;

FIG. 5 is an enlarged fragmentary front view showing the manner in which the melted region shown in FIG. 3 is grown;

FIG. 6 is a graph showing by way of example the manner in which a pressing force programmed by a control program changes with time;

FIG. 7 is a graph showing by way of example the manner in which an actual pressing force changes with time under the control program shown in FIG. 6;

FIG. 8 is an enlarged fragmentary front view of a spot welding apparatus which carries out a spot welding method according to another embodiment of the present invention; and

FIG. 9 is an enlarged fragmentary front view showing the manner in which a modification of the spot welding method according to the other embodiment is carried out by the spot welding apparatus shown in FIG. 8.

### DESCRIPTION OF THE PREFERRED EMBODIMENTS

Spot welding methods according to preferred embodiments of the present invention will be described in detail below with reference to the accompanying drawings.

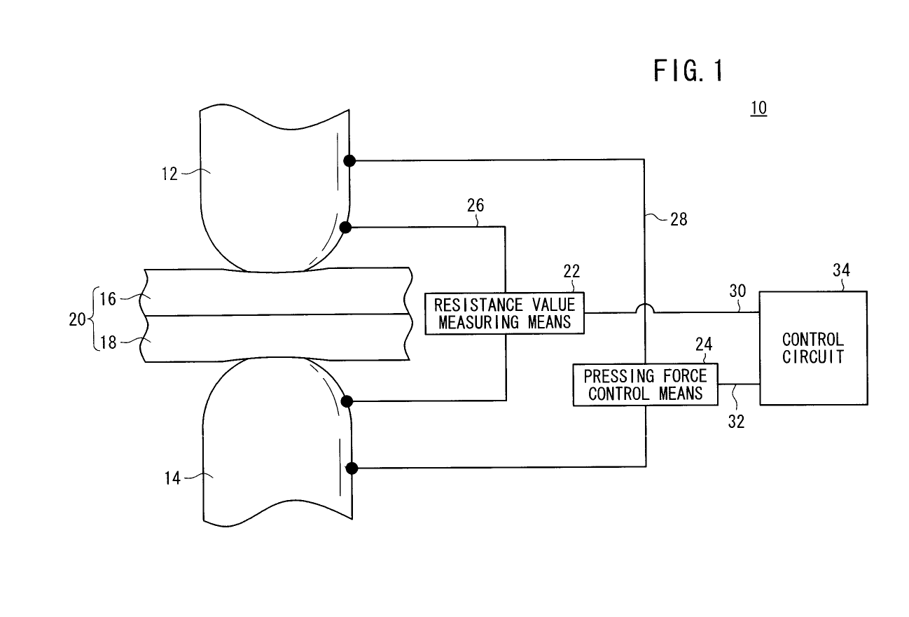

FIG. 1 is an enlarged fragmentary front view, partly in block form, of a spot welding apparatus 10 which carries out a spot welding method according to an embodiment of the present invention. As shown in FIG. 1, the spot welding apparatus 10 includes a welding gun, not shown, having a first electrode tip 12 and a second electrode tip 14, each in the form of a long bar. The welding gun is mounted on the distal end of an arm of a multijoint robot such as a six-axis robot, for example.

If the welding gun is a so-called X-shaped welding gun, then the first electrode tip 12 is mounted on one of a pair of openable and closable chucks and the second electrode tip 14 is mounted on the other chuck. The chucks can be opened or closed by a servomotor, for example, to move the first electrode tip 12 and the second electrode tip 14 away from each other when the chucks are opened, and toward each other when the chucks are closed.

If the welding gun is a so-called C-shaped welding gun, then the second electrode tip 14 is mounted on the distal end of a fixed arm and the first electrode tip 12 is operatively coupled to a ball screw that can be rotated about its own axis by a servomotor, for example. When the ball screw is rotated about its own axis in one direction or the other by the servomotor, the first electrode tip 12 is moved toward or away from the second electrode tip 14.

The X-shaped welding gun or C-shaped welding gun mounted on the arm of a multijoint robot is well known in the art, and will not be described in detail below. In the present embodiment, it is assumed that an electric current flows from the first electrode tip 12 to the second electrode tip 14 which is disposed below the first electrode tip 12.

The first electrode tip 12 and the second electrode tip 14 grip an object to be welded therebetween, and supply an electric current through the object. According to the present invention, for an easier understanding of the present invention, the object to be welded comprises a stacked assembly 20 including a first metal sheet 16 and a second metal sheet 18 which are superposed one on the other as metal workpieces.

The first metal sheet 16 and the second metal sheet 18, which are in the form of flat sheets, should preferably made of Fe-base alloy such as high tension steel, soft steel, or the like. However, the first metal sheet 16 and the second metal sheet 18 may be made of any metals other than Fe-base alloy insofar as they can be spot-welded. In addition, the first metal sheet 16 and the second metal sheet 18 may be made of the same metal or different metals.

The spot welding apparatus 10 further includes a resistance value measuring means 22 for directly or indirectly measuring the electric resistance between the first electrode tip 12 to the second electrode tip 14 which are gripping the stacked assembly 20, and a pressing force control means 24 for controlling the pressing force applied from the first electrode tip 12 and the second electrode tip 14 to the stacked assembly 20. The resistance value measuring means 22 and the pressing force control means 24 are electrically connected to the first electrode tip 12 and the second electrode tip 14 by signal lines 26, 28.

If the welding gun is an X-shaped welding gun, then the pressing force control means 24 controls the servomotor to control the force with which to close the chucks. If the welding gun is a C-shaped welding gun, then the pressing force control means 24 controls the servomotor to control the rotational force applied to the ball screw. When the pressing force control means 24 controls the servomotor in this manner, the pressing force applied from the first electrode tip 12 and the second electrode tip 14 to the stacked assembly 20 is controlled.

The resistance value measuring means 22 and the pressing force control means 24 are electrically connected to a control circuit 34 by signal lines 30, 32. The control circuit 34 can supply a command signal to the pressing force control means 24 based on information representative of the electric resistance measured by the resistance value measuring means 22.

A power supply, not shown, such as an AC welding power supply or the like, for example, is electrically connected to the control circuit 34. The power supply has a positive terminal and a negative terminal which are electrically connected to the first electrode tip 12 and the second electrode tip 14, respectively. The power supply may comprise a capacitor-discharge-type welding power supply, an inverter welding power supply, a transistor welding power supply, or the like.

A spot welding method according to the present embodiment which is carried out by the spot welding apparatus 10 that is basically constructed as described above will be described below with respect to operation of the spot welding apparatus 10.

For spot-welding the stacked assembly 20, i.e., for joining the first metal sheet 16 and the second metal sheet 18 to each other, the multijoint robot moves the welding gun to place the stacked assembly 20 between the first electrode tip 12 and the second electrode tip 14.

Then, the control circuit 34 energizes the servomotor to close the chucks or rotate the ball screw to move downward so that the first electrode tip 12 and the second electrode tip 14 approach each other until the first electrode tip 12 and the second electrode tip 14 grip the stacked assembly 20 therebetween.

When the first electrode tip 12 and the second electrode tip 14 grip the stacked assembly 20 therebetween, the pressing force control means 24 controls the rotational force generated by the servomotor to apply a prescribed pressing force from the first electrode tip 12 and the second electrode tip 14 to the stacked assembly 20. Specifically, the first electrode tip 12 and the second electrode tip 14 press the stacked assembly 20 therebetween under an initial pressing force. The first metal sheet 16 and the second metal sheet 18 are held in surface-to-surface contact with each other over a prescribed area of contact, forming a contact interface.

The resistance value measuring means 22 directly measures or indirectly measures, i.e., calculates, the electric resistance value from the first electrode tip 12 to the second electrode tip 14 while the first electrode tip 12 and the second electrode tip 14 are gripping and pressing the stacked assembly 20. The resistance value measuring means 22 sends the measured electric resistance value as information via the signal lines 26, 30 to the control circuit 34 at all times.

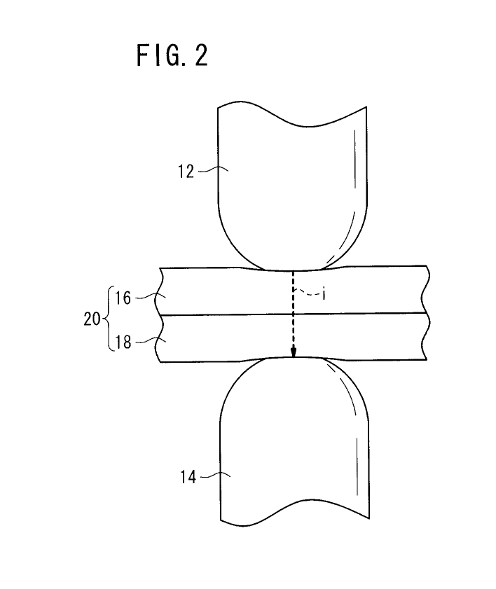

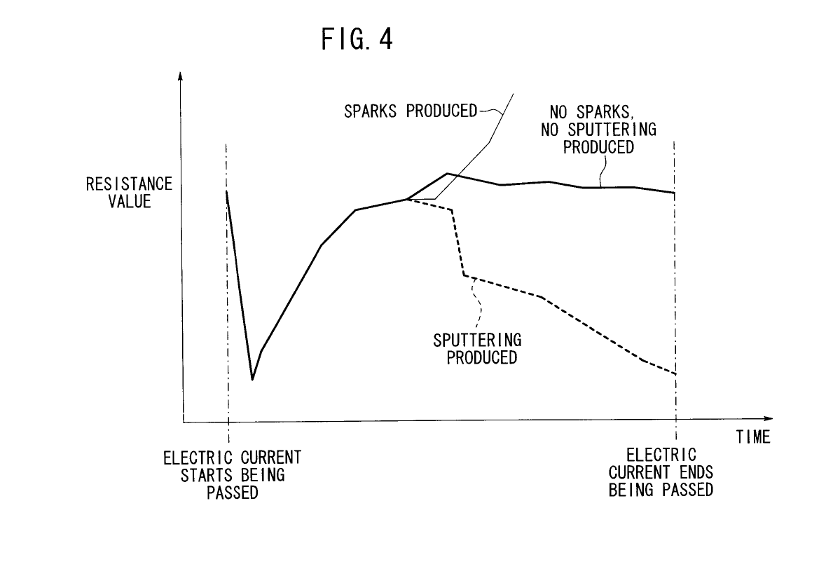

Then, the control circuit 34 starts to pass an electric current through the stacked assembly 20. Specifically, since the first electrode tip 12 and the second electrode tip 14 are connected respectively to the positive and negative terminals of the power supply, not shown, an electric current i flows from the first electrode tip 12 to the second electrode tip 14, as shown in FIG. 2. Since the contact interface between the first metal sheet 16 and the second metal sheet 18 has a contact resistance, the contact interface generates Joule heat as the electric current i flows thereacross. As a result, regions of the first metal sheet 16 and the second metal sheet 18 in the vicinity of the contact interface are heated. During this time, the electric resistance value from the first electrode tip 12 to the second electrode tip 14, which is measured by the resistance value measuring means 22, sharply increases at a high rate as can be seen from FIG. 4. FIG. 4 is a graph showing how the electric resistance value from the first electrode tip 12 to the second electrode tip 14 changes with time from the time when the electric current starts being passed between the first electrode tip 12 and the second electrode tip 14 to the time when the electric current ends being passed between the first electrode tip 12 and the second electrode tip 14.

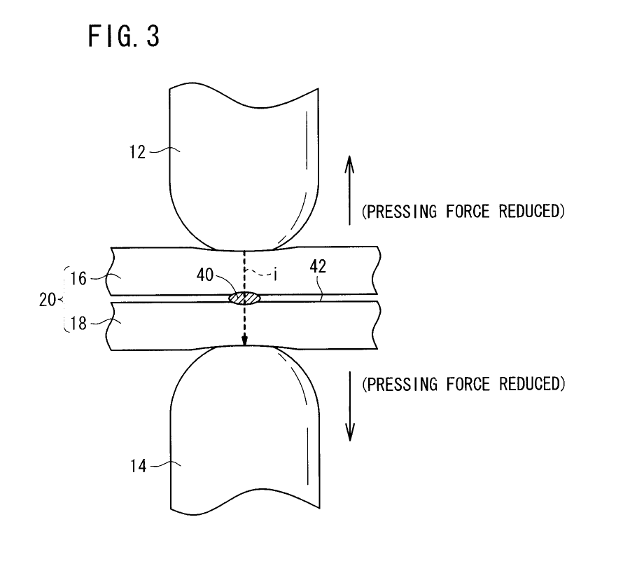

When the contact interface is thus heated, its temperature rises so high that it is melted into a melted region 40 between the first metal sheet 16 and the second metal sheet 18, as shown in FIG. 3. As shown in FIG. 4, when the melted region 40 is formed, the electric resistance value from the first electrode tip 12 to the second electrode tip 14, which is measured by the resistance value measuring means 22, increases at a reduced rate.

Stated otherwise, it is possible to detect when the melted region 40 (see FIG. 3) is formed based on the information indicating that the rate at which the electric resistance value measured by the resistance value measuring means 22 (see FIG. 1) increases is reduced. When the control circuit 34 (see FIG. 1) receives the information from the resistance value measuring means 22 via the signal line 30, the control circuit 34 immediately supplies a command signal for reducing the rotational force generated by the servomotor to the pressing force control means 24 via the signal line 32.

In response to the control signal supplied from the control circuit 34 via the signal line 32, the pressing force control means 24 issues a command signal for reducing the rotational force generated by the servomotor via the signal line 28. The pressing force applied from the first electrode tip 12 and the second electrode tip 14 to the stacked assembly 20 is now reduced. At this time, as shown in FIG. 3, there may be developed a slight clearance 42 between the first metal sheet 16 and the second metal sheet 18.

The rate at which the pressing force applied from the first electrode tip 12 and the second electrode tip 14 to the stacked assembly 20 is set to such a level that the melted region 40 is kept in contact with both the first metal sheet 16 and the second metal sheet 18 and the first electrode tip 12 and the second electrode tip 14 are not displaced away from the first metal sheet 16 and the second metal sheet 18, respectively. In this manner, an electric current path is maintained from the first electrode tip 12 to the second electrode tip 14. Consequently, the electric current i keeps flowing from the first electrode tip 12 across the stacked assembly 20 to the second electrode tip 14 even after the pressing force is reduced.

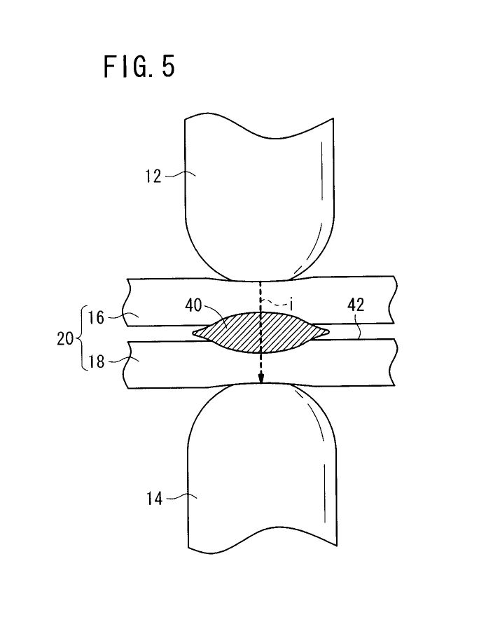

As the pressing force is reduced, the area of contact between the first metal sheet 16 and the second metal sheet 18 decreases, resulting in an increase in the contact resistance of the contact interface. Therefore, the contact interface continuously generates Joule heat, causing the melted region 40 to grow larger as shown in FIG. 5.

At this time, excessively large forces are prevented from being applied to the melted region 40 because the pressing force applied to the stacked assembly 20 has been reduced as described above. Consequently, the melted region 40 tends to press the first metal sheet 16 and the second metal sheet 18 apart from each other, enlarging the clearance 42.

Therefore, the melted region 40 is prevented from being crushed and hence sputtering is prevented from taking place while the welding process is in progress.

When the pressing force is reduced, the area of contact between the first electrode tip 12 and the first metal sheet 16, and the area of contact between the second metal sheet 18 and the second electrode tip 14, as well as the area of contact between the first metal sheet 16 and the second metal sheet 18, are also reduced. As shown in FIG. 4, if the contact resistance between these metal sheets and the electrode tips is excessively large, then sparks are liable to be produced across their contact regions. According to the present embodiment, a prescribed pressing force is applied to the stacked assembly 20 to prevent the contact resistance from becoming excessively large even after the pressing force is reduced, so that no sparks will be produced.

Stated otherwise, after the pressing force is reduced, it is set to such a level that areas of contact for preventing sparks from being produced are maintained between the first electrode tip 12 and the first metal sheet 16, between the second metal sheet 18 and the second electrode tip 14, and between the first metal sheet 16 and the second metal sheet 18. Therefore, sparks are reliably prevented from being produced. FIG. 4 also shows the electric resistance value from the first electrode tip 12 to the second electrode tip 14 which changes with time when both sputtering and sparks do not take place.

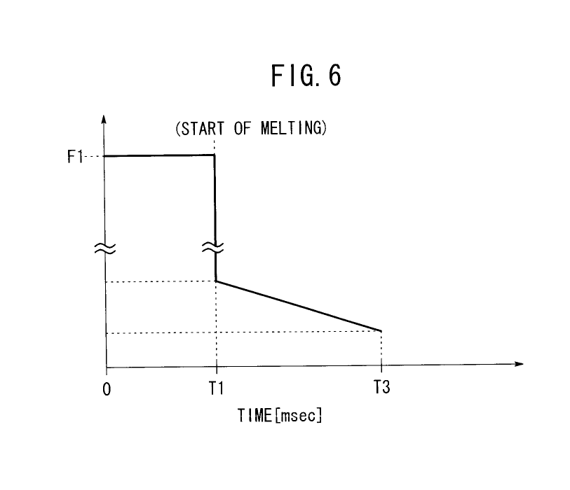

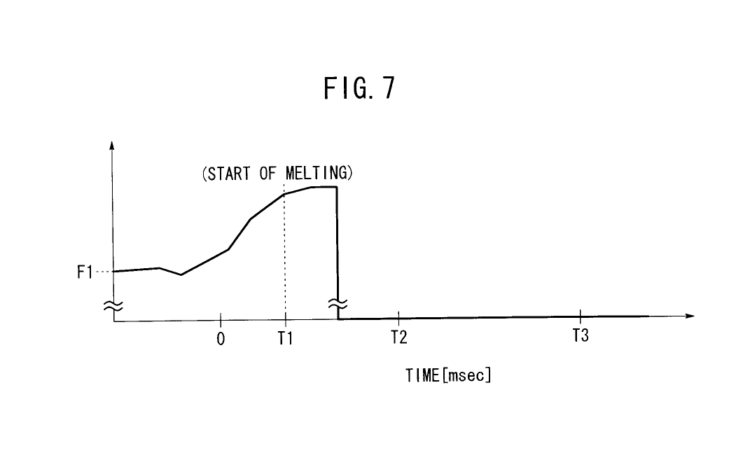

FIG. 6 is a graph showing by way of example the manner in which a pressing force programmed by a control program changes with time, and FIG. 7 is a graph showing by way of example the manner in which an actual pressing force changes with time under the control program shown in FIG. 6. A comparison between FIG. 6 and FIG. 7 shows that when the pressing force control means 24 is programmed by a suitable control program, it can appropriately reduce the pressing force applied to the stacked assembly 20 to cause the electric resistance value from the first electrode tip 12 to the second electrode tip 14 to change with time as shown in FIG. 4. As a result, both sputtering and sparks are prevented from taking place.

After the melted region 40 is sufficiently grown upon elapse of a certain time, the power supply is turned off to stop the electric current, or at least either one of the first electrode tip 12 and the second electrode tip 14 is moved away from the stacked assembly 20 thereby electrically insulating the first electrode tip 12 and the second electrode tip 14 from each other. The Joule heat now stops being generated, so that the melted region 40 is cooled and solidified into a nugget in a solid phase. According to the present embodiment wherein the pressing force applied to the stacked assembly 20 is reduced at the same time that the melted region 40 is formed, since the melted region 40 is grown to a large size, it is possible to produce a large nugget.

The first metal sheet 16 and the second metal sheet 18 are joined to each other by the nugget. Since the nugget is grown to a large size, the first metal sheet 16 and the second metal sheet 18 are joined into a joined assembly in which the bonding strength of the first metal sheet 16 and the second metal sheet 18 is excellent.

According to the present embodiment, furthermore, sputtering and sparks are effectively prevented from taking place.

In the above embodiment, it is judged that the melted region 40 is formed in the contact interface between the first metal sheet 16 and the second metal sheet 18 by detecting when the rate at which the electric resistance value from the first electrode tip 12 to the second electrode tip 14 increases is reduced. However, the formation of the melted region 40 in the contact interface between the first metal sheet 16 and the second metal sheet 18 may be judged according to an ultrasonic detecting process.

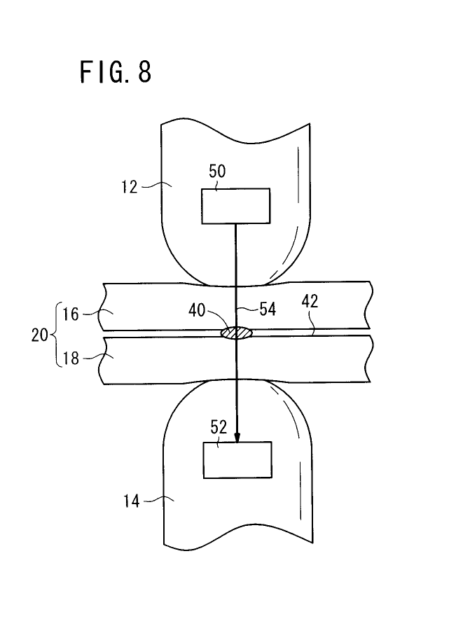

Such an ultrasonic detecting process will be described below with reference to FIG. 8.

As shown in FIG. 8, an ultrasonic transmitter and receiver 50 which is capable of emitting and receiving an ultrasonic wave is incorporated in the first electrode tip 12, and an ultrasonic receiver 52 which is capable of receiving an ultrasonic wave is incorporated in the second electrode tip 14.

The ultrasonic transmitter and receiver 50 and the ultrasonic receiver 52 are connected to an echo measurement unit, not shown. The echo measurement unit can measure the velocity of an ultrasonic wave, i.e., a transmitted wave 54, which has been sent from the ultrasonic transmitter and receiver 50 and reached the ultrasonic receiver 52.

The velocity of the transmitted wave 54 decreases as the temperature of the stacked assembly 20 rises. While the first metal sheet 16 and the second metal sheet 18 being spot-welded, when the high-temperature melted region 40 is formed in the contact interface, the velocity of the transmitted wave 54 decreases. It can thus be judged that the high-temperature melted region 40 is formed in the contact interface when the echo measurement unit detects the reduction in the velocity of the transmitted wave 54.

The rate at which the temperature of the stacked assembly 20 increases is large until the melted region 40 is formed. When the melted region 40 is formed, the rate at which the temperature of the stacked assembly 20 increases is reduced. Accordingly, a change in the rate at which the temperature of the stacked assembly 20 increases, rather than a change in the velocity of the transmitted wave 54, may be detected to determine whether the melted region 40 is formed or not.

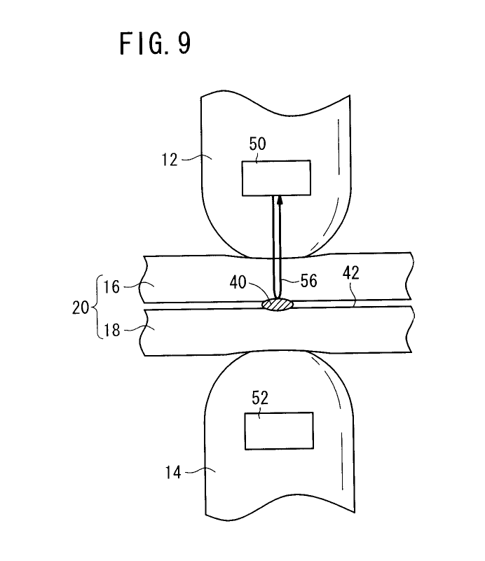

A modification of the above ultrasonic detecting process will be described below with reference to FIG. 9.

As shown in FIG. 9, the ultrasonic transmitter and receiver 50 which is incorporated in the first electrode tip 12 receives an ultrasonic wave, i.e., a reflected wave 56 which has returned to the ultrasonic transmitter and receiver 50. The echo measurement unit can confirm that the reflected wave 56 is received by the ultrasonic transmitter and receiver 50. In FIG. 9, the ultrasonic receiver 52 is shown as being incorporated in the second electrode tip 14. However, the ultrasonic receiver 52 may be dispensed with.

An ultrasonic wave is generally a mixture of longitudinal and transverse waves. The longitudinal wave can pass through both a solid phase and a liquid phase, whereas the transverse wave can pass through only a solid phase, but not a liquid phase. In an initial stage of the spot welding process where the melted region 40 has not yet been formed, the ultrasonic wave emitted from the ultrasonic transmitter and receiver 50 all passes through the stacked assembly 20. However, when the melted region 40 is formed, the transverse wave of the ultrasonic wave emitted from the ultrasonic transmitter and receiver 50 is reflected by an interface of the melted region 40 and returns as the reflected wave 56 to the ultrasonic transmitter and receiver 50.

Consequently, it can be judged that the melted region 40 is formed in the contact interface when the echo measurement unit detects the return of the reflected wave 56 to the ultrasonic transmitter and receiver 50.

After it is judged that the melted region 40 is formed in the contact interface, the pressing force applied to the stacked assembly 20 can be reduced.

The object to be welded is not limited to the stacked assembly 20 which comprises the first metal sheet 16 and the second metal sheet 18. However, the object to be welded may be a stacked assembly of flat portions of metal workpieces which have any shapes.

Although certain preferred embodiments of the present invention have been shown and described in detail, it should be understood that various changes and modifications may be made therein without departing from the scope of the appended claims.

What is claimed is:

1. A spot welding method comprising the steps of:
pressing a plurality of metal workpieces under a pressing force with a pair of electrode tips by gripping superposed regions of the metal workpieces, thereby bringing the metal workpieces into contact with each other to form a contact interface therebetween;
passing an electric current between the pair of electrode tips;
determining whether the contact interface is melted or not; and
simultaneously when it is judged that the contact interface is melted, reducing the pressing force applied from the pair of electrode tips to the metal workpieces to such a level that the pair of electrode tips and the metal workpieces are kept in contact with each other, the metal workpieces are kept in contact with each other, and the electric current keeps flowing between the pair of electrode tips.

2. The spot welding method according to claim 1, wherein it is judged that the contact interface is melted when the value of an electric resistance between the pair of electrode tips is changed.

3. The spot welding method according to claim 1, wherein it is judged that the contact interface is melted when a velocity or a rate of change in the velocity of an ultrasonic wave emitted toward the contact interface is changed.

4. The spot welding method according to claim 3, wherein one of the pair of electrode tips incorporates therein an ultrasonic transmitter and receiver and another one of the pair of electrode tips incorporates therein an ultrasonic receiver, and the velocity or the rate of change in the velocity of the ultrasonic wave emitted toward the contact interface is measured using the ultrasonic transmitter and receiver and the ultrasonic receiver.

5. The spot welding method according to claim 1, wherein it is judged that the contact interface is melted when an ultrasonic wave is emitted toward the contact interface and a reflected wave is returned from the contact interface.

6. The spot welding method according to claim 5, wherein at least one of the pair of electrode tips incorporates therein an ultrasonic transmitter and receiver, and the reflected wave which is returned from the contact interface is detected by the ultrasonic transmitter and receiver.
